(19) United States
(12) Patent Application Publication
(10) Pub. No.: US 2022/0146869 A1
(43) Pub. Date: May 12, 2022

(54) ANTI-REFLECTIVE SWITCHABLE PANEL AND METHODS FOR MAKING AND USING

(71) Applicant: Jiansheng WANG, The Colony, TX (US)

(72) Inventor: Jiansheng WANG, The Colony, TX (US)

(21) Appl. No.: 16/701,785

(22) PCT Filed: Apr. 16, 2019
(86) PCT No.: PCT/US2019/027707

§ 371 Date: Dec. 3, 2019

Related U.S. Application Data
(60) Provisional application No. 62/762,368, filed on May 1, 2018.

(51) Int. Cl. G02F 1/1334; G02F 1/1335; G02F 1/1343; G09G 3/36

(52) U.S. Cl. CPC G02F 1/1334; G02F 1/133502; G02F 2201/38; G09G 3/36; G02F 1/13439

(57) ABSTRACT

A panel apparatus comprises a switchable film such as liquid crystal switchable film. The transparent electrode such as indium tin oxide (ITO) included in the apparatus is replaced with index matched indium tin oxide (IMITO). The solid/air interface included in the apparatus is replaced with an anti-reflective coating.

### REFERENCE TO RELATED APPLICATIONS

This application claims the benefit of US provisional patent application Serial Number U.S. 62/762,368 filed May 1, 2018, and PCT Application Serial Number PCT/US2019/027707 filed Apr. 16, 2019, the entire contents of which are incorporated herein by reference for all purposes.

### FIELD

The present disclosure is directed toward anti-reflective systems and methods of use on switchable panels, and more particularly to systems and methods for anti-reflective panels using liquid crystal microdroplet (LCMD) devices, suspended particle device (SPD), electrochromic or thermochromic materials. In some embodiments, the disclosure provides improvements related to U.S. Pat. Nos. 9,690,174B2 and 9,921,425B2,

### BACKGROUND

Continued advancements in the field of optoelectronics have led to the development of liquid crystal microdroplet (LCMD) displays. In this type of display, liquid crystal (LC) material is contained in microdroplets embedded in a solid polymer matrix. Birefringence results from a material having a different index of refraction in different directions. The extraordinary index of refraction (nₑ) of a liquid crystal molecule is defined as that measured along the long axis of the molecule, and the ordinary index of refraction (nₒ) is measured in a plane perpendicular to the long axis. The dielectric anisotropy of liquid crystals is defined as Δε=ε_{∥}−ε_{⊥}, where ε_{∥} and ε_{⊥}, are parallel and perpendicular dielectric constants, respectively. Liquid crystals having a positive dielectric anisotropy (Δε>0) are called positive-type liquid crystals, or positive liquid crystals, and liquid crystals having a negative dielectric anisotropy (Δε<0) are called negative-type liquid crystals, or negative liquid crystals. The positive liquid crystals orient in the direction of an electric field, whereas the negative liquid crystals orient perpendicular to an electric field. These electro-optical properties of liquid crystals have been widely used in various applications.

One approach to obtaining dispersed microdroplets in a polymer matrix is the method of encapsulating or emulsifying the liquid crystals and suspending the liquid crystals in a film which is polymerized. This approach is described, for example, in U.S. Pat. Nos. 4,435,047; 4,605,284; and 4,707,080. This process includes mixing positive liquid crystals and encapsulating material, in which the liquid crystals are insoluble, and permitting formation of discrete capsules containing the liquid crystals. The emulsion is cast on a substrate, which is precoated with a transparent electrode, such as an indium tin oxide (ITO) coating, to form an encapsulated liquid crystal device.

LCMD displays may also be formed by phase separation of low-molecular weight liquid crystals from a prepolymer or polymer solution to form microdroplets of liquid crystals. This process, described in U.S. Pat. Nos. 4,685,771 and 4,688,900, includes dissolving positive liquid crystals in an uncured resin and then sandwiching the mixture between two substrates which are precoated with transparent electrodes. The resin is then cured so that microdroplets of liquid crystals are formed and uniformly dispersed in the cured resin to form a polymer dispersed liquid crystal (PDLC) device. When an AC voltage is applied between the two transparent electrodes, the positive liquid crystals in microdroplets are oriented and the display is transparent if the refractive index of the polymer matrix (nₚ) is made to equal the ordinary index of the liquid crystals (nₒ). The display scatters light in the absence of the electric field, because the directors (vector in the direction of the long axis of the molecules) of the liquid crystals are random and the refractive index of the polymer cannot match the index of the liquid crystals. Nematic liquid crystals having a positive dielectric anisotropy (Δε>0), large Δn, which may contain a dichroic dye mixture, can be used to form a transparent and an absorbing mode.

LCMD displays may be characterized as normal mode displays or reverse mode displays. A normal mode display containing liquid crystals is non-transparent (scattering or absorbing) in the absence of an electric field and is transparent in the presence of an applied electric field. A reverse mode display is transparent in the absence of an electric field and is non-transparent (scattering or absorbing) in the presence of an applied electric field. A LCMD film usually has following layer structure: transparent film/ITO coating/liquid crystal matrix layer/ITO coating/transparent film. The liquid crystal matrix layer is also called the active layer and is responsible for the switching function. Other types of switchable film, such as for example, suspended particle devices (SPD), electrochromic materials or thermochromic materials, have similar structure but different active layers.

Previously, LCMD could only be used indoors because of concerns about UV stability and moisture sensitivity of components, and narrow temperature ranges for use. However, recent innovations have led to the development of outdoor and projection applications, such as for example, switchable projection windows, building advertising and windows for automobile and cruise ship, as shown in U.S. Pat. No. 9,690,174 B2 and U.S. Pat. No. 9,921,425 B2 and Published US Patent Applications. No. US 2015/0275090 A1 and No. US 2016/0243773 A1.

In order to make LCMD film more durable and useful, a LCMD film is often laminated between two layers of glass with interlayers or assembled into a multi-layer window, as discussed herein. Such a laminated glass panel is often called a smart glass or switchable window. Such a multi-layer panel is called a switchable projection panel or window.

There exists a need for devices that use improved LCMD technologies in projection systems and switchable window systems to provide improved viewing quality with reduced or unnoticeable reflections. These methodologies should also be able to be used to reduce reflections on similar devices like suspended particle device (SPD), electrochromic or thermochromic materials.

### SUMMARY

In one embodiment, a panel apparatus comprises a liquid crystal microdroplet (LCMD) film switchable between transparent and opaque states in response to a change in an applied electrical voltage, wherein transparent electrode of indium tin oxide (ITO) in the LCMD film is replaced with index matched indium tin oxide (IMITO) to reduce reflections and/or the solid/air or film/air interface is treated with anti-reflective (AR) coating.

In another embodiment, a panel apparatus comprises a laminated switchable glass with a liquid crystal microdroplet (LCMD) film. Two glass layers and two interlayer layers sandwich or laminate the LCMD layer in center. Transparent and conductive electrode ITO in the LCMD film is replaced with IMITO, and/or the glass/air interface is treated with anti-reflective coating.

In another embodiment, a panel apparatus comprises a multi-layered switchable glass panel with a liquid crystal microdroplet (LCMD) film. The apparatus includes first layer or a liquid crystal microdroplet (LCMD) display switchable between transparent and opaque states in response to a change in an applied electrical voltage. Transparent and conductive electrodes of ITO in the LCMD film is replaced with IMITO. The panel apparatus also includes a second layer apart from and coupled to the first layer. The second layer includes a transparent panel or glass layer. Two glass layers sandwich the LCMD film layer in center with an air gap between glass layer and the LCMD film. All of solid/air interfaces including film/air interface and glass/air interfaces may be treated with anti-reflective (AR) coating.

Additional aspects, features, and advantages of the present disclosure will become apparent from the following detailed description.

### BRIEF DESCRIPTION OF THE DRAWINGS

The present disclosure is best understood from the following detailed description when read with accompanying figures. It is emphasized that, in accordance with the standard practice in the industry, various features are not drawn to scale and are used for illustration purpose only. In fact, the dimension of the various features may be arbitrarily increased or reduced for clarity of discussion.

FIG. 1 is a cross-sectional view of a normal LCMD film structure according to an embodiment of the present disclosure.

FIG. 2 is a cross-sectional view of a normal laminated LCMD panel according to an embodiment of the present disclosure.

FIG. 3 shows a laser testing setting and results with a normal laminated LCMD panel and display board.

FIG. 4 shows a relationship between refractive index of ITO and wavelengths.

FIG. 5 is a cross-sectional view of an improved laminated LCMD panel apparatus with reduced reflections according to one or more embodiments of the present disclosure, wherein regular transparent electrodes ITO in the LCMD film are replaced with IMITO and glass/air interface is treated with anti-reflective coating.

FIG. 6 is a cross-sectional view of a normal switchable projection panel with LCMD film according to an embodiment of the present disclosure.

FIG. 7 is a cross-sectional view of an improved switchable projection panel with LCMD film according to an embodiment of the present disclosure, wherein regular transparent electrodes ITO in the LCMD film are replaced with IMITO and film/air and glass/air interfaces are treated with anti-reflective coating.

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

As used herein the term “LCMD device” or “LCMD film” or “LCMD display” means a device or film or display, respectively, formed using various classes of polymer films. For example, an LCMD device may be formed using nematic curvilinear aligned phase (NCAP) films, such as material and devices described in U.S. Pat. No. 4,435,047 filed Sep. 16, 1981 disclosing “Encapsulated Liquid Crystal and Method,” which is incorporated by reference herein in its entirety for all purposes and teachings. An LCMD device may also be formed using polymer dispersed liquid crystal (PDLC) films formed using phase separation in a homogenous polymer matrix, such as material and devices described in U.S. Pat. No. 4,688,900 filed Sep. 17, 1985 disclosing “Light Modulating Material Comprising a Liquid Crystal Dispersion in a Plastic Matrix,” which is incorporated by reference herein in its entirety for all purposes and teachings. An LCMD device may also be formed using a non-homogenous polymer dispersed liquid crystal display (NPD-LCD) formed using a non-homogenous light transmissive copolymer matrix with dispersed droplets of liquid crystal material, such as material and devices described in U.S. Pat. No. 5,270,843 filed Aug. 31, 1992 disclosing “Directly Formed Polymer Dispersed Liquid Crystal Light Shutter Displays,” which is incorporated by reference herein in its entirety for all purposes and teachings. Other forms of liquid crystal microdroplet films may also be suitable. A NPD-LCD device may be configured in one of two modes. In a positive mode, an NPD-LCD device is switchable between an opaque state without an applied electrical voltage and clear state with an applied electrical voltage. In a negative mode, an NPD-LCD device is switchable between a clear state without an applied electrical voltage and an opaque state with an applied electrical voltage.

In the last decade, usage of switchable panels in a variety of applications, such as for energy efficient glazing, privacy windows, automobile windows and projection widow advertising, has increased dramatically. This is largely due to the fact that, the special features provided by these products, such as front or rear projection and no changes to the natural light spectrum during use, are now available to be used for outdoor applications. However, reflection during use of these devices seriously affects many applications such as use as building glass or automobile glass and can impact viewing comfort, performance and safety. Reflection can also impact image quality during display of information in building advertising or window advertising applications. Consequently, reflection on switchable devices remains a primary concern.

### Problems

Unwanted reflections exist in many kinds of switchable devices. In this disclosure, liquid crystal (LC) switchable devices are used as an exemplary example. The principle and method discussed in this disclosure may apply to other systems. One reason to choose liquid crystal type switchable devices for this detailed discussion is that liquid crystal type switchable device is switchable between opaque and clear modes without a tint and has the highest transparency compared to other types of switchable devices. That is, as devices of this type are most vulnerable to unwanted reflections, any solution that is suitable for liquid crystal-based devices will be suitable for other similar devices as well.

There are three major structures described in this disclosure. These are (1) a switchable film or panel, such as a switchable LCMD film, which has the following layer structure: transparent film/ITO transparent electrode/LC-polymer matrix/ITO transparent electrode/transparent film. The LC-polymer matrix is an optically active layer which is responsible for the switching function; (2) a laminated liquid crystal switchable glass with the following layer structure: glass/interlayer/switchable LCMD film/interlayer/glass; and (3) a switchable projection panel with the following layer structure: glass/air gap/switchable LCMD film/air gap/glass. Other types of switchable film basically have same layer structure but with different optically active layers.

When using these switchable films or panels, reflection reduces transmittance and interferes with viewing during see-through applications and/or reduces the quality of projected images during opaque applications. For example, when an LCMD film is taped onto an existing window for use as a switchable privacy curtain and/or as a projection screen, reflections reduce clarity of see-through during transparent mode and quality of projected images during opaque mode. As another example, when a laminated switchable glass is used as a partition panel between a cab's driver and passenger compartment, the driver can be distracted by reflections from the partition panel visible in the rear-view mirror. The problems caused by reflection on switchable panels have become more and more serous in recent years, as a result of LCMD devices being widely used for outdoor applications made possible by improvements in UV, heat and temperature tolerance, and also because natural light can be much brighter that the brightness generated by artificial light sources such as for example during use in a conference room.

Another example is that when using a switchable projection panel as described in U.S. Pat. Nos. 9,690,174 and 9,921,425 with a normal projector, a strong reflection from a projector will disturb viewing of projected images. Similarly, when a laminated switchable glass is used as a switchable window in transparent mode, such as a partition for hospital operation room or a factory production area, reflections from the laminated switchable glass reduce clarity.

As will be appreciated by one of skill in the art, reflection in switchable panel apparatuses is considered to be a complicated process, impacted not only by reflected light but also by scattered light and refracted light as well as by the variety of interfaces formed by the different materials used in the manufacture of the apparatuses. This is often compounded by the fact that it can be difficult to accurately determine the refractive index of some of these compounds. As discussed below, the contribution of these various components to reflection in switchable panel apparatuses has been difficult to isolate and quantify using traditional methods and instruments, such as various photometers and microscopies. This analysis is made even more complicated by the presence of multiple layers.

Previous attempts to resolve this reflection problem have included use of tinted interlayers and tinted glass. While these treatments reduce unwanted reflections, they have a negative impact on image quality and image brightness. This tinting also changed image color and caused changes to the spectrum of natural light. As is known to those of skill in the art, natural light is better for human health and for indoor plant growth than artificial light. Accordingly, the use of tinted interlayers and tinted glass is not suitable for applications that require high quality lighting such as within hospitals, schools and classrooms.

Another attempt to reduce reflection involved shifting the refractive indexes of the LC-polymer layer such that it was closer to the refractive index of the ITO electrode. However, the higher refractive index was generated by using aromatic compounds in the liquid crystals and the monomers forming the polymers. This reduced the operational temperature range of the LCMD, particularly at the lower end of the temperature range.

Due to great difficulty, this problem remains unsolved for decades. This disclosure first introduces solutions which solve the problems of reflection but does not bring any negative impact to the system.

### Solutions

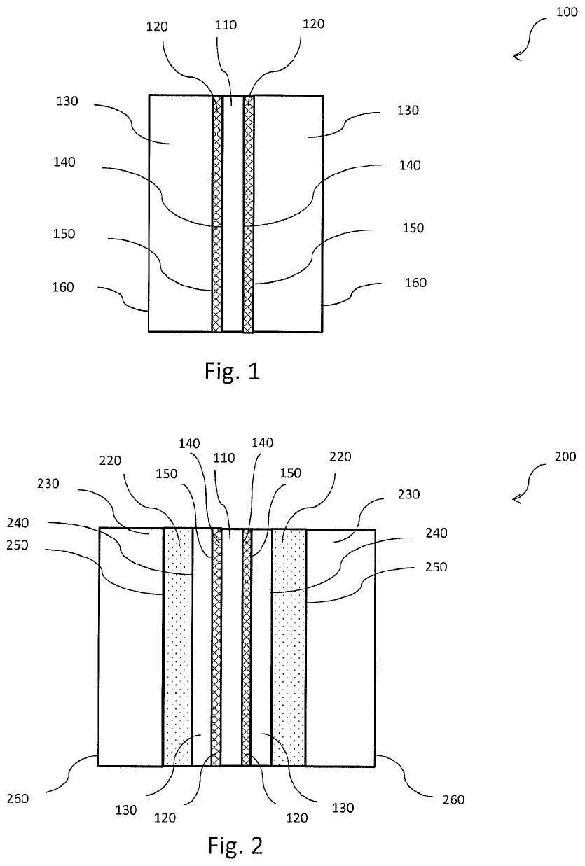

In order to eliminate or reduce reflection, it is necessary first to understand the interactions between the structures that compose the switchable devices and find out where the reflections are coming from. Referring to FIG. 1, a cross-sectional view of layer structure of normal LCMD film 100 is illustrated. LCMD film structure 100 includes a liquid crystal (LC)-polymer matrix layer 110, a transparent electrode 120, such as an indium tin oxide (ITO) coating, and a transparent plastic film 130, such as polyethylene terephthalate (PET) or polycarbonate. There are three different interfaces in LCMD film 100. Interface 140 between LC-polymer matrix 110 and ITO 120 and interface 150 between ITO 120 and film 130 are solid-solid interfaces. Film surface 160 is a solid-air interface. Techniques and treatments to eliminate or reduce reflections from both ITO related interfaces, such as ITO/film interface and ITO/LC-polymer interface, and solid/air interface like glass/air interface or film/air interface are discussed below.

FIG. 2 is a cross-sectional view of a laminated LCMD panel 200. The LCMD film 100 is laminated between two layers of glass 230 with adhesive interlayer 220. The interlayer material may be selected from, for example, polyvinyl butyral (PVB), ethylene vinyl acetate (EVA) or thermoplastic polyurethane (TPU) for thermal lamination and acrylate, epoxy or polyurethane for liquid lamination. A thermal lamination is usually conducted with an interlayer in an autoclave or a vacuum oven. The thermoplastic interlayer is melted in a high temperature and pressure or vacuum to bond different layers together. A liquid lamination is usually conducted with a mixture of liquid resins which is cured to form a polymer and bond different layers together. An interface 240 between transparent plastic film 130 and the interlayer 220 and an interface 250 between the interlayer 220 and the glass 230 are solid-solid interfaces. Glass surface 260 is a solid-air interface. As used herein, the term “laminated” refers to layered structures in which an LCMD film and one or more layers of glass are separated by an adhesive interlayer extending across substantially the entire interface between the LCMD film and the glass. When an LCMD film is laminated into two layers of glass with interlayers, original film surface or solid-air interface 160 is replaced with a solid-solid interface or a film/interlayer interface 240. The term “glass” as used herein includes silicon based transparent panel, such as soda-lime silicate glass and borosilicate glass, and polymer based transparent panel, such as acrylic glass and polycarbonate glass.

A transparent substance has its refractive index, expressed as “n”. Whether an interface will reflect light or not depends on the relative difference between the refractive indexes of the substances forming the interface, which is expressed as “Δn”. An interface formed by substances with the same refractive indexes does not reflect light at all and does not refract light either. Since this disclosure is mainly dealing with reflection, to simplify the discussion, refractive behavior in the light path is ignored in the drawings. Reflective intensity depends on Δn, or the difference between the refractive indexes of the elements that form the interface. Gases such as air have much smaller reflective indexes than solids, therefore, an untreated solid-air interface usually has a strong reflection, for example, 4% reflection for glass at vertical incident angle. As discussed herein, examples of such solid-air surfaces include the glass surface(s) and the film surface(s) of some constructs. Removing or reducing reflections from such surfaces is a focal point of present disclosure. A solid-solid interface with a large difference between the two refractive indexes may also have a strong reflection, which is another focal point of the present disclosure. A solid-solid interface with a small Δn, or a small difference in refractive indexes, has a weak reflection, which will not be discussed in detail in the present disclosure, because a human's eyes are usually not sensitive enough to detect such weak reflections. The weak reflections also are not shown up in the drawings to simplify the discussion.

Anti-reflection is an active field in the electronic display industry, especially those applications using indium tin oxide (ITO) as a transparent electrode. ITO has a high refractive index, around 2.0, therefore, a reflection on any ITO interface is strong. There are several technologies that have been used to reduce reflection caused by the ITO layer, for example the single layer method and the multi-layer method. The single layer approach reduces the reflective index of ITO to match or get close to the reflective index of the other material that forms the interface. For example, if the other material is glass, the ITO refractive index must be reduced from 2.0 to a refractive index of about 1.5. The reflective index of ITO may be reduced by different ways of sputtering, such as the oblique-angle deposition technique. As the deposition angle increases, the porosity of the ITO film increases and the refractive index decreases. Therefore, the difference between reflective indexes Δn of a film-ITO interface is reduced, thereby achieving a reduction in reflection. The multi-layer (two or more layers) method uses interference to achieve an anti-reflection effect. By using alternating layers of a low-index material and a higher-index material and by controlling thickness of layers to obtain an opposite phase, reflections from the different layers may cancel each other, therefore, an overall reduction in reflection is produced. The word “matching” or “matched” means a result for eliminating or reducing reflection by using a technology such as the single layer technique or multi-layer technique.

Both single layer and multi-layer ITO film products are just available commercially. In present disclosure, our main focus is to use existing anti-reflection products on new systems related to switchable devices such as the laminated LC switchable panel and switchable projection panel. As will be appreciated by one of skill in the art, during outdoor applications, the potential brightness from natural light is significantly stronger, for example, tens of times stronger than the brightness generated by artificial lights, that is, “indoor light”. Because of this increased brightness, the reflection problem reaches an irreconcilable level. Reflection also has a serious impact on many recently developed features related to projection, such as front projection and rear projection, 360 degree viewable display and spherical scattering.

For all of the commercially available anti-reflection ITO film or anti-reflection glass, to simplify discussion in present disclosure, a single layer is used to represent a treated interface without mentioning what technology or principle is used to achieve anti-reflection on film or glass. For example, a single layer may be illustrated in this disclosure as an index matched indium tin oxide (IMITO) layer without distinguishing how the anti-reflection is achieved by using single layer technique or multi-layer technique. A single layer may be also used in claims as an index matched indium tin oxide (IMITO) layer without distinguishing how the anti-reflection is achieved by using single layer technique or multi-layer technique.

There has been very little published about the study of anti-reflection of complicated products such as laminated LC switchable panels. As discussed above, one reason may be the lack of effective tools for studying such complicated products. Although many kinds of photometers and micrometers are known and are useful in the study of liquid crystal display (LCD), these instruments are not helpful in studying reflection on LC switchable panels, because scattered light is mixed with reflected light and refracted light. Furthermore, reflected light changes with switching and under different conditions, and it is difficult to determine the refractive index of the LC-polymer layer. Scattered light may be a disturbing factor on the study with photometers and micrometers, plus different optic behaviors occurs on multi layered structure which are close in nanometers and all of this can change when the status of the switchable panel changes. To resolve reflections on a switchable film or glass, it is necessary first to understand reflection behavior and where these reflections come from and which interface is responsible for which reflection.

After many experiments, a successful experiment has been found that confirms reflective layers and interfaces. This invention will for the first time reveal how to locate reflective layers within a multiple layer structure and explain an optic mechanism of reflection and solve reflection problem on switchable devices like LCMD panels. The present disclosure introduces a very useful way to locate reflective layers. Although this experiment does not directly give an answer about reflecting interface but with a series of obviations, operations and logical analysis, it may clearly verify the predicated reflective surfaces with optic theory.

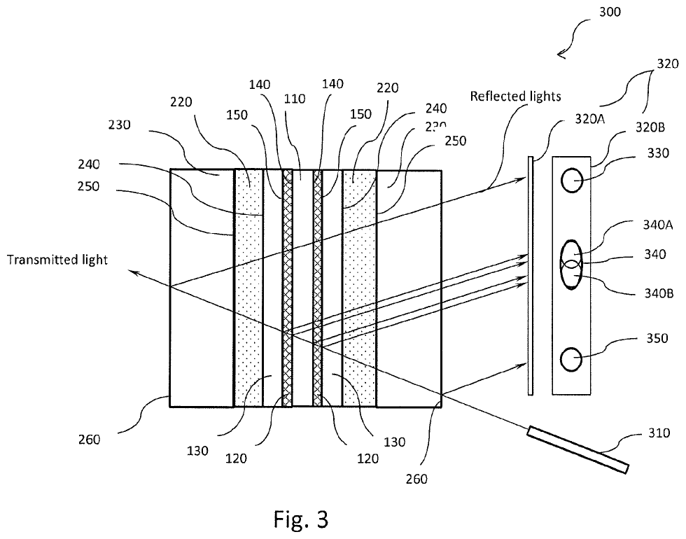

With reference to FIG. 3 or 300, a method for finding reflective surfaces in a laminated LC switchable panel multi-layer structure is described, in which a laser experiment is carried out with a green beam laser 310. For example, the laser may be applied to a laminated LC switchable panel 200 at an incident angle of for example about 45 degrees. Then a voltage is applied to transparent ITO electrodes 140. To receive and show reflective spots, a black board 320 (320A is its section view and 320B is its front view) may be placed in parallel with the panel 200 at a suitable distance, such as 30 cm away from the panel 200. Increasing distance has an “enlargement” effect on a reflective spot so that it can be determined whether a reflective spot is formed by a single interface or by multiple interfaces which are close together. If a spot is formed from two or multiple interfaces, the original spot will be split into two or more smaller spots as distance between the black board and the panel increases. These smaller spots contain detailed information about interfaces which are close together for example, separated by micrometers or nanometers. The specific distances and laser angle can also be used to quantitatively calculate actual distances between reflective interfaces. As will be apparent to one of skill in the art, while longer distances increase the “enlargement” effect, the sharpness of reflective spot(s) may be reduced if distance is too great. Observation is conducted in a dark environment. Reflection spots are shown on the black board 320B when the switchable panel 200 is in transparent state. A top spot 330 on the black board 320B is reflected from the back glass surface 260 that is distal to the black board 320, while the bottom spot 350 is reflected from the glass surface 260 close to the black board 320. In black board 320B, three are three reflective spots shown, and top spot 330 and bottom spot 350 are near round and center spot 340 has an oval shape. As can be seen, this experiment can provide important information, that is, in this example, that there is another reflection resource contributing between two glass surfaces 260. Since scattering on a LC-polymer layer in opaque mode goes in all directions, intensity at a particular angle is weak, therefore this experiment has successfully excluded scattered light as scattered light can't reach the black board 320 with enough intensity to be seen. However, this result includes some assumptions. In order to clearly explain the observation, the oval shaped center spot 340 is illustrated with as two spots: spot 340A and spot 340B, in fact, it is formed by spots 340A and 340B, when the switchable panel 200 is in a transparent state. Actually, spot 340A and spot 340B come from two ITO related interfaces as illustrated in FIG. 3, however, because the thickness of ITO 120 is only a dozen nanometers, it forms one spot to human eyes. To prove reflection spot 330 is from glass far from black board (back glass surface), a black tape may be placed on laser pointing area of the back surface, and then reflection spot 330 disappears because a back surface is removed. So, when the black tape is present, the black board shows two spots, that is one oval spot in center and one round spot in bottom because the black tape forms an interface with the glass that prevents reflection at this surface When the switchable panel is in the scattering or opaque state, top spot 330 and half of the oval spot or spot 340A disappears and oval spot 340 changes to a round spot 340B, because only the one ITO related interface on the right side reflects the laser beam. So, the black board shows two spots, or one round spot 340B and bottom spot 350, because the incident light can't pass directly through the LC-polymer layer 110, meaning that the reflective layers and surfaces on the left side of layer 110 do not contribute to reflection under these conditions. More information can be obtained by considering data relating to layer thickness and distances between the spots and distance between the panel 200 and black board 320. The experiment results are summarized in table 1.

TABLE 1

| Experimental condition | Observed reflection spots |
|---|---|
| Panel 200 is in transparent state | Spot 330, 340 and 350 |
| without a black tape in back surface | |
| Panel 200 is in transparent state | Spot 340 and 350 |
| with a black tape in back surface | |
| Panel 200 is in scattering state with or | Spot 340B and 350 |
| without a black tape in back surface | |

It is necessary point out that the actual observed spot 340 is not like what is illustrated, that is, with a large separation between 340A and 340B. 340A and 340B are very close because the actual thickness of the LC-polymer layer is about 20 micrometers and the thickness of the ITO is about 15 nanometers, therefore, the switching of the panel has the effect of changing the intensity on one spot with a little shape change.

This well-designed experiment not only uses a relatively long distance to successfully isolate reflective lights from scattered lights but also uses different reflection spots in different conditions to confirm actual reflective layers. Observed results with numbers of reflective spots, distances between spots and shapes of spots and brightness of spots can be used for understanding and localizing reflective interfaces with known optics. This experiment confirms that the ITO layers are reflective surfaces and for the first time answers why a LCMD device in the transparent state has stronger reflections than normal glass with both experimental results and optic analysis and, of course, provides specific details for avoiding reflections on LCMD panels. Previously, there were no successful solutions developed for reducing or eliminating reflections that were not accompanied with a negative impact on performance within the industry. (Note: It has mentioned above that this experiment for the first-time answers why a LCMD device in the transparent state has stronger reflections than normal glass with both experimental results and optic analysis)

A reflection is determined by Snell's law and the refractive indexes of the substances. A Fresnel reflection is generated from an interface with Δn greater than zero. The greater the difference in Δn, the stronger the Fresnel reflection. A mismatch in the refractive index between layers will result in a Fresnel reflection and loss of transmittance at each interface. Therefore, refractive index-matched structures will minimize Fresnel reflection losses.

Referring to FIG. 2 and FIG. 3, let's look at all of the layers in a laminated switchable glass 200 again, with a layer structure of glass/interlayer/film/ITO/LC-Polymer matrix/ITO/film/interlayer/glass and refractive indexes. Table 2 shows refractive indexes with a layer structure of laminated LC switchable glass or glass/PVB/PET/ITO/LC-Polymer/ITO/PVB/glass. Since the laminated LC switchable panel 200 is symmetrical, if the switchable LCMD film is in the opaque state, the incident laser light can't pass through the LC-Polymer layer, therefore, only half of the structure of the laminated LC switchable glass 200 is needed. In order to use actual data, transparent plastic film is PET and interlayer is PVB.

TABLE 2

| Layer Material | Air | Glass | PVB | PET | ITO | LC/Polymer |
|---|---|---|---|---|---|---|
| Refractive Index n | 1.00 | 1.52 | 1.485 | 1.575 | 1.90 | 1.52 |

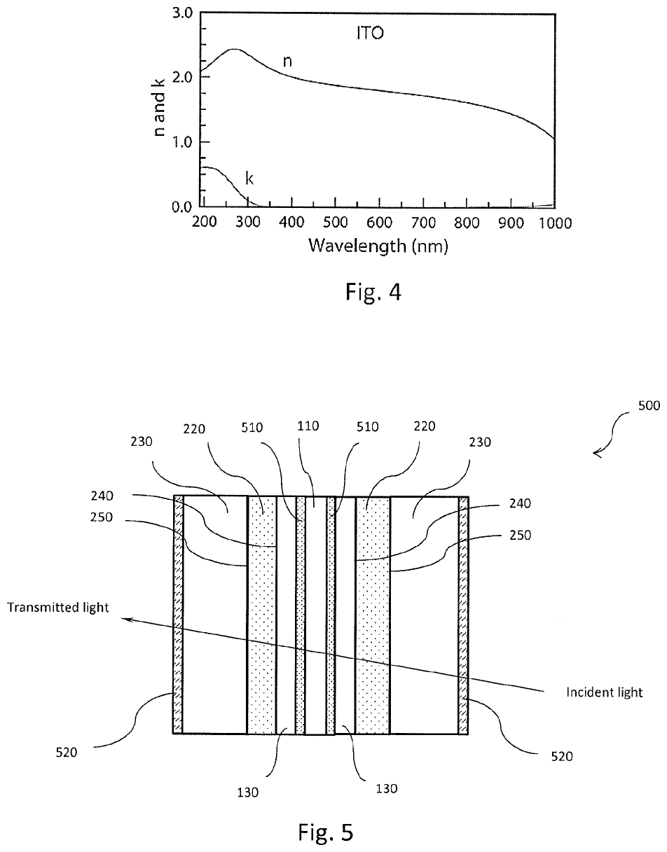

FIG. 4 shows that refractive indexes of ITO coating are changeable with different wavelength, at green laser with 530 nm wavelength, refractive index of ITO is 1.90.

Since refractive indexes of ITO is changeable in range of visible wavelength, choosing a green laser with 530 nm wavelength may be close to average of daylight or yellow light at 550 nm. Since reflection is depended on different refractive indexes Δn at an interface. An at different interfaces are listed in table 3.

TABLE 3

| Interface | Glass/air | Glass/PVB | PVB/PET | PET/ITO | ITO/LC-Polymer |
|---|---|---|---|---|---|
| Δn | 0.52 | 0.035 | 0.09 | 0.325 | 0.38 |

As shown in table 3 and the laser experiment, three interfaces have large Δn's which may generate strong reflections, specifically, the of Glass/air and PET/ITO and ITO/LC-Polymer interfaces. Other interfaces with small Δn do not generate notable reflections as observed in the experiment and as such are not detected by human eyes. That is why using a black board is used to review reflective spots. If using a white paper or board, weak reflective spots will also be seen in total darkness. However, these spots would not be visible in bright light situation, therefore, involving such weak reflective spots is not helpful for the analysis. Since the thickness of the ITO layer is only a dozen nanometers, the two interfaces of PET/ITO and ITO/LC-Polymer actually generate only one spot of reflection, because they are in such close proximity. Therefore, we know that the two side reflective spots are generated by glass/air interfaces and that the center reflective spot is from interfaces of PET/ITO and ITO/LC-Polymer.

A light path way with strong reflections is illustrated in FIG. 3. As shown in FIG. 3 six interfaces with large Δn could theoretically generate strong reflections. These reflections indicated with six parallel arrows reduce clarity of view for see-through when a LCMD is in a clear state, and generate blur for projection when a LCMD is in an opaque state. The ITO layer needs to be treated to eliminate or reduce reflections from the ITO related interfaces.

Referring to FIG. 5, in order to reduce the strong reflections from a laminated LC switchable glass 200, great differences of refractive indexes Δn at those interfaces need to be reduced. Two techniques are used to solve the reflection problem. Using anti-reflective glass or glass coated with anti-reflective coating 520 to reduce the reflection from air-glass interface. Using refractive index matched ITO 510 to reduce the reflections from PET/ITO interface and ITO/LC-Polymer interface.

Anti-reflective glass is commercially available and its optic mechanism of anti-reflection is well-known. Since Δn of glass/PVB interface or glass/interlayer interface is already very small (Δn=0.035), the anti-reflective glass only needs to have anti-reflective coating at one side or outer side for reducing cost. As discussed above, while tinted glass also reduced reflection, the tinted glass also altered the color spectrum of displayed images. However, surprising, the anti-reflective coatings have no effect on the color spectrum, resulting in images that are clear and sharp. As will be appreciated by one of skill in the art, this eliminates the contributions of two factors that were long considered to confound the analysis of reflection in switchable panel device apparatuses: scattered light and the complicated structure of the LCMD device. As discussed above, this test allows for the analysis of reflection in total isolation from scattering lights, which confound the results and analyses of traditional tests. Furthermore, as discussed above, this test has determined that the reflective spot from ITO actually comes from two reflective interfaces. Surprisingly, in this testing, the complicated structure of the LCMD device did not confound or confuse the results, but instead, helped to find the answer. This is because, without a switching function, it would have been hard to determine that a normal ITO reflection was formed by two reflections, and then it would be difficult to explain why the reflection of the LCMD is so strong. The strongness is because it combines two reflections.

Refractive index matched ITO film or IMITO 510 is a relative new product in the market. It is just commercially available in some large coating companies such as Sheldahl. The transmittance of refractive IMITO film may be improved from about 78% to 94%.

By using these two improved parts, or anti-refractive glass and refractive index matched ITO film, the optic quality of a laminated switchable glass is greatly improved as a result of total removal of the noticeable reflections, as illustrated in FIG. 5. A laser test at similar conditions mentioned before has no bright spot on a LC switchable panel following the anti-reflective treatments. No noticeable reflection can be seen.

Apparatus 500 or laminated LC switchable glass may be any silicon-based glass like annealed glass, clear glass or temped glass, or polymer based glass like acrylic and polycarbonate panel. The film may be organic polymer film such as polyethylene terephthalate (PET) film or polycarbonate film.

Suspended particle device (SPD), electrochromic and thermochromic materials have similar structures and applications as switchable windows or energy saving sunroof and the same problem with unwanted reflections. As discussed here, this methodology will resolve the reflection problems on those devices as well.

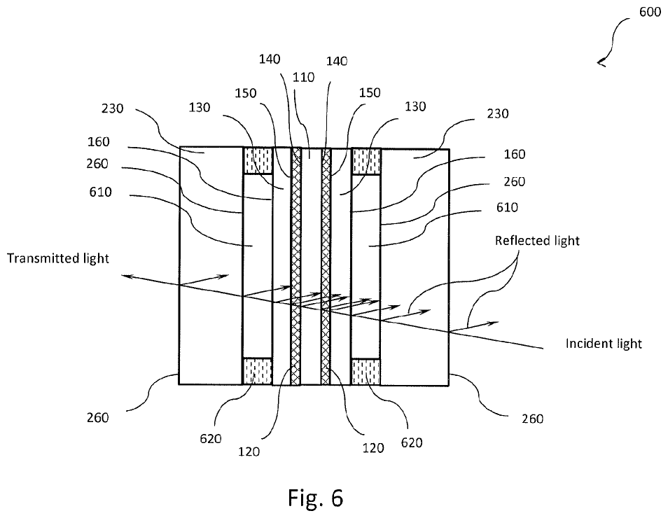

Similarly, these technical methods can be used to improve optical quality of traditional Switchable Projection Panel 600, illustrated in FIG. 6, which is shown in a cross-sectional view. Ten interfaces with large Δn existed may have strong reflections. The reflections are illustrated with 10 parallel arrows. The optic quality may be greatly improved by putting anti-reflective coating on any or all of solid-air interfaces and replacing regular ITO 120 with IM ITO 510. The apparatus 600 includes the layered LCMD film 100 positioned between two layers of glass 230. A seal 620 extends around a perimeter between the glass 230 and the LCMD film 100. The seal 620 traps an air layer 610 between the LCMD film 100 and the glass 230. Thus, interface 260 between the glass 230 and the air layer 610, and the interface 160 between the transparent plastic film 130 and air layer 610 are solid-air interfaces with large Δn having strong reflections.

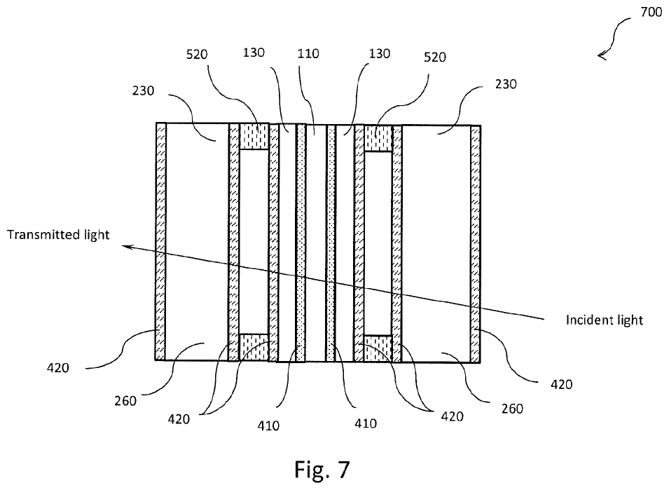

FIG. 7 is a cross-sectional view of an improved Switchable Projection Panel 700, in which all of solid-air interfaces are coated with anti-reflective coating 520 and regular ITO coating 120 is replaced with refractive IM ITO 510. Interface 260 between the glass 230 and the air layer 510 and the interface 160 between the transparent plastic film 130 and the air layer 510 are coated with anti-reflective coating 520. When an incident light passes through the panel as illustrated in FIG. 7, there is no interface with a large Δn in the light path, therefore, strong reflections are eliminated or reduced, and meaning that viewers will have a clear view. The transmittance is increased too, when a LCMD film is in the transparent mode. When the LCMD film is in the opaque mode and receives projected images, the projected images are no longer disturbed with noticeable reflections.

In summary, this disclosure introduces two methods to eliminate or reduce reflections from switchable devices, that is, the use of IMITO to replace regular ITO and to add anti-reflective coating to glass/air interface or film/air interface. The glass layers included in FIG. 7 provide rigidity and protection from scratches. For uses where scratches are not a concern, one of the glass layers may be eliminated.

Suspended particle device (SPD), electrochromic or thermochromic materials has similar applications as switchable windows and have the same problems with unwanted reflections. As discussed herein, this methodology will also resolve the reflection problem on those devices. With basic layer structures described above, a different optically active layer determines a type of switchable panel. An optically active layer maybe selected from LCMD material, SPD material, electrochromic material or thermochromic material.

A switchable film may have following layer structures: transparent film/ITO transparent electrode/optically active layer/ITO transparent electrode/transparent film. In structure of the switchable film, there are two film/air interfaces or outer surfaces of two layers of transparent films. There are two methods to eliminate or reduce reflection on the switchable film, or replacing ITO transparent electrode with IMITO transparent electrode and coating film/air interface with anti-reflective coating. Each method has the effect of reducing reflection, the combination of the two methods is better, but costs are different. These methods and combination of the methods may be selected in different applications.

A switchable panel may have two structures, or laminated switchable panel and switchable projection panel. In structure of the switchable projection panel, there is two types of solid/air interfaces or film/air interface and glass/air interface. In structure of laminated switchable panel, there is only one type of solid/air interface or glass/air interface, because an original film/air interface is replaced with solid/solid interface or film/interlayer interface after lamination. There are two methods to eliminate or reduce reflection, including replacing ITO transparent electrode with IMITO transparent electrode and coating solid/air interface with anti-reflective coating. Each method has the effect of reducing reflection, the combination of the two methods is better, but costs are different. These methods and combination of the methods may be selected in different applications. The solid may be film or glass. Solid/air interface may be film/air interface and glass/air interface.

What is claimed is:

1. A switchable panel apparatus having reduced reflection comprising:
a first layer comprising an optically active layer selected from the group consisting of: a liquid crystal microdroplet device (LCMD) material; a suspended particle device (SPD) material; an electrochromic material; and a thermochromic material, said optically active layer changeable in transmittance in response to a change of applied electrical voltage;
a second layer, wherein said second layer is transparent;
a third layer placed between said first layer and said second layer, wherein said third layer includes an index matched indium tin oxide (IMITO) transparent electrode; and
a fourth layer, wherein said fourth layer is transparent and has at least one outer surface that is a solid/air interface.

2. The switchable panel apparatus of claim 1, wherein said switchable panel apparatus further comprises a fifth layer, said fifth layer is transparent and is in contact with said second layer and said fourth layer, said fifth layer selected from the group consisting of: polyvinyl butyral (PVB); ethylene vinyl acetate (EVA); thermoplastic polyurethane (TPU); and a polymer formed from a liquid resin.

3. The switchable panel apparatus of claim 1, wherein said outer surface is treated with an anti-reflective coating.

4. The switchable panel apparatus of claim 1, wherein said fourth layer is spaced apart from and coupled to said first layer by an air gap.

5. The switchable panel apparatus of claim 4, wherein said second layer further comprises a solid/air interface and said solid/air interface is treated with anti-reflective coating.

6. A method for making or using a switchable panel apparatus having reduced reflection comprising:
installing a switchable panel apparatus, said switchable panel apparatus comprising:
a first layer comprising an optically active layer selected from the group consisting of: a liquid crystal microdroplet device (LCMD); a suspended particle device (SPD); an electrochromic material; and a thermochromic material, said optically active layer changeable in transmittance in response to a change in an applied electrical voltage; and
a second layer comprising transparent film layer; and
a third layer placed between said first layer and said second layer, wherein said third layer includes an index matched indium tin oxide (IMITO) transparent electrode; and
a fourth layer, wherein said fourth layer is transparent and has at least one outer surface that is a solid/air interface.

7. The method according to claim 6, wherein said switchable panel apparatus further comprises a fifth layer, said fifth layer is transparent and is in contact with said second layer and said fourth layer, said fifth layer selected from the group consisting of: polyvinyl butyral (PVB); ethylene vinyl acetate (EVA); thermoplastic polyurethane (TPU); and a polymer formed from a liquid resin.

8. The method according to claim 6 wherein said outer surface is coated with an anti-reflective coating,

9. The method according to claim 6 wherein said fourth layer is spaced apart from and coupled to said first layer by an air gap, said second layer comprising a film/air interface, said film/air interface is coated with anti-reflective coating.

10. The method according to claim 6 wherein the switchable panel apparatus is arranged such that:
a first layer comprises the optically active layer;
a second layer comprises a transparent film; and
a third layer comprises a transparent electrode, said transparent electrode being placed in contact between the first layer and the second layer, said third layer having a refractive index that is matched or close with a refractive index of the second layer; and
a fourth layer comprises a transparent glass.

11. The method of claim 6 wherein the switchable panel further comprises at least one film layer and at least one glass layer and at least one interlayer, wherein said interlayer being placed in contact between said film layer with a film/interface and said glass layer with an interlayer/glass interface.

12. The method of claim 11, wherein the exterior surface is coated with an anti-reflective coating.

13. A switchable film apparatus having reduced reflection comprising:
a first layer, wherein said first layer comprising an optically active layer selected from the group consisting of: a liquid crystal microdroplet device (LCMD) material; a suspended particle device (SPD) material; an electrochromic material; a thermochromic material, said optically active layer changeable in transmittance in response to a change of applied electrical voltage; and
a second layer, wherein said second layer is transparent film and has at least one film/air interface, wherein said film/air interface is coated with anti-reflective coating; and
a third layer, wherein said third layer includes an index matched indium tin oxide (IMITO) transparent electrode, placed between said first layer and said second layer.
